(19) United States
(12) Patent Application Publication
(10) Pub. No.: US 2009/0059403 A1
(43) Pub. Date: Mar. 5, 2009

(54) Vehicle Detection and Alert System with Blind Spot Elimination Function

(76) Inventor: Chia-Jung Chang, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/197,361

(22) Filed: Aug. 25, 2008

(30) Foreign Application Priority Data
Aug. 30, 2007 (TW) 096214463

(51) Int. Cl. B60R 1/08

(52) U.S. Cl. 359/843

(57) ABSTRACT

The invention relates to a modified structure for automatic rear view mirror, especially a vehicle detection and alert system with blind spot elimination function. It consists of a rear view mirror main body that contains a lens; a driving motor that is installed inside the rear view mirror main body and connects to the lens to control the lens angle; a sensor that is installed inside the rear view mirror main body to detect approaching objects; a control chip module that is installed inside the rear view mirror main body and connects with the sensor and the driving motor to receive the detection signals from the sensor and control the driving motor to obtain the optimal lens angle. Thus, the driver safety is greatly improved.

### BACKGROUND OF THE INVENTION

1. Field of the Invention

The invention relates to a modified structure for automatic rear view mirror, especially a vehicle detection and alert system with blind spot elimination function.

2. Description of the Prior Art

Traditional rear view mirrors usually have serious blind spots, i.e. the area the driver cannot see. For example, the vision of drivers is restricted by car pillars and viewing angle range for rear view mirrors when the vehicle is turning or shifting lanes. Particularly when there is an approaching vehicle from behind, due to blind spots the driver could think there is no approaching vehicle from behind and lead to traffic accidents. Similarly, when a vehicle is backing into garage or parking along roadside, collision tends to occur because the vision of drivers is restricted by car pillars and viewing angle range for rear view mirrors.

In view of the above situations, the invention proposed a vehicle detection and alert system with blind spot elimination function to solve the problems with the traditional technology.

### SUMMARY OF THE INVENTION

The main objective for the invention is to provide a vehicle detection and alert system with blind spot elimination function. Therefore, a sensor is installed inside rear view mirror to detect things around the vehicle. When an object is approaching the vehicle, a control chip module driven motor will move the rear view mirror to enlarge viewing angle and eliminate blind spots and improve driver safety.

Another objective for the invention is to provide a vehicle detection and alert system with blind spot elimination function. Therefore, through control chip (intellectual sensor), signal light switch, gear shift stick and multi-angle control button, the viewing angle for rear view mirrors can be adjusted automatically or manually to eliminate blind spots.

To achieve the above objectives, the invention involves an improved structure for automatic rear view mirrors, especially a vehicle detection and alert system with blind spot elimination function. It consists of a rear view mirror main body that contains a lens; a driving motor that is installed inside the rear view mirror main body and connects to the lens to control the lens angle; a sensor that is installed inside the rear view mirror main body to detect approaching objects; a control chip module that is installed inside the rear view mirror main body and connects with the sensor and the driving motor to receive the detection signals from the sensor and control the driving motor to obtain the optimal lens angle. In this way, the driver safety is improved.

The following provides detailed description with embodiments and illustrative diagrams to further explain the objectives, technical content and features, and the achieved functions for the invention.

### DETAILED DESCRIPTION OF THE PREFERRED EMBODIMENT

For the examiners to further understand the advantages and the achieved functions by the invention, a detailed description with illustrative diagrams is provided in the following.

FIG. 1 is a three-dimensional diagram for the vehicle detection and alert system with blind spot elimination function for the invention. FIG. 2 is an embodiment for the vehicle detection and alert system with blind spot elimination function for the invention. FIG. 3 is a block diagram to represent the vehicle detection and alert system with blind spot elimination function for the invention. As shown in the figures, the invention consists of a rear view mirror main body 10 that contains a lens 101; a driving motor 12 that is installed inside the rear view mirror main body 10 and connects to the lens 101 to control the lens 101 angle; a sensor 14 that is installed inside the rear view mirror main body 10 to detect the approaching objects or vehicles 16; a control chip module 18 that is installed inside the rear view mirror main body 10 and connects with the sensor 14 and the driving motor 12 to receive the detection signals from the sensor 14 and control the driving motor 12 to obtain the optimal lens 101 angle and improve driver safety.

The signal wire for the control chip module 18 connects to the signal light switch stick. Through activating a signal light, the control chip module 18 sends out a signal to control lens 101 angles. The signal wire for the control chip module 18 can also connect to the vehicle gearshift stick. Through the vehicle gear shift stick, the control chip module 18 can enable the lens 101 to tilt downward and allow adjustment for the down view angle for the driver to eliminate blind spots.

The control chip module 18 allows adjustment for multiple view angles by the driver. Besides, the control chip module 18 can memorize multiple lens angles for custom view angle adjustment for different drivers. The control chip module 18 can further connect to a multi-angle control button, which comprises a switch knob, a switch stick or a press button and can be installed in a car door, a dashboard, a steering wheel or a gearshift stick to adjust the lens 101 angle and provide improved driver safety.

Further, the control chip module can memorize multiple lens 101 angles. Custom view angle adjustment can be achieved through the multi-angle control switch of a switch knob, a switch stick or a press button, or automatically by the sensor 14. The control chip module 18 can be installed in a door car, a dashboard, a steering wheel or a gearshift stick with wire or wireless connection. As soon as the sensor 14 detects an approaching object or vehicle, it will automatically activate the blind spot elimination function and the rear view mirror will open outward. As a result, the driver blind spots will be eliminated. Further, an alert device can be installed inside the vehicle, so when the sensor detects an approaching object or vehicle, the alert device will flash and beep to remind the driver to watch the rear view mirrors. Further with the control chip from the invention, the driver safety is improved when the lens angle is widened to eliminate blind spots. Particularly, the invention is very user-friendly.

Please refer to FIG. 3 for another feature for the invention that it further comprises a digital image display unit 20 that provides real-time view for the driver. The digital image display unit 20 connects to the control chip module 18 and is installed inside the vehicle.

In summary, the invention is a breakthrough over traditional technology and can indeed achieve the desired function. It is not easily attainable by people familiar with the arts and techniques in this field. Besides, the invention has never been published, so its progressiveness and utility apparently makes it meet the patent application requirements. A patent application is thus submitted. It would be appreciated for the authority to approve the application that would encourage creation and invention.

The description above is merely for the concepts and characteristics for the invention. The purpose for the description is to let people familiar with the arts and techniques to understand the contents and embodiments for the invention, but is not to limit the scope of the invention. Those equivalent changes or modifications based on the disclosed principles and concepts for the invention shall all fall within the range of the invention claims.

Specific Drawing:

(1) The designated diagram for the present invention is FIG. (1).

(2) The legends for the components

| | | | |
|---|---|---|---|
| 10 | rear view mirror main body | 14 | sensor |
| 101 | lens | 18 | control chip module |
| 12 | driving motor | | |

### BRIEF DESCRIPTION OF THE DRAWINGS

FIG. 1 is a three-dimensional diagram for the vehicle detection and alert system with blind spot elimination function for the invention.

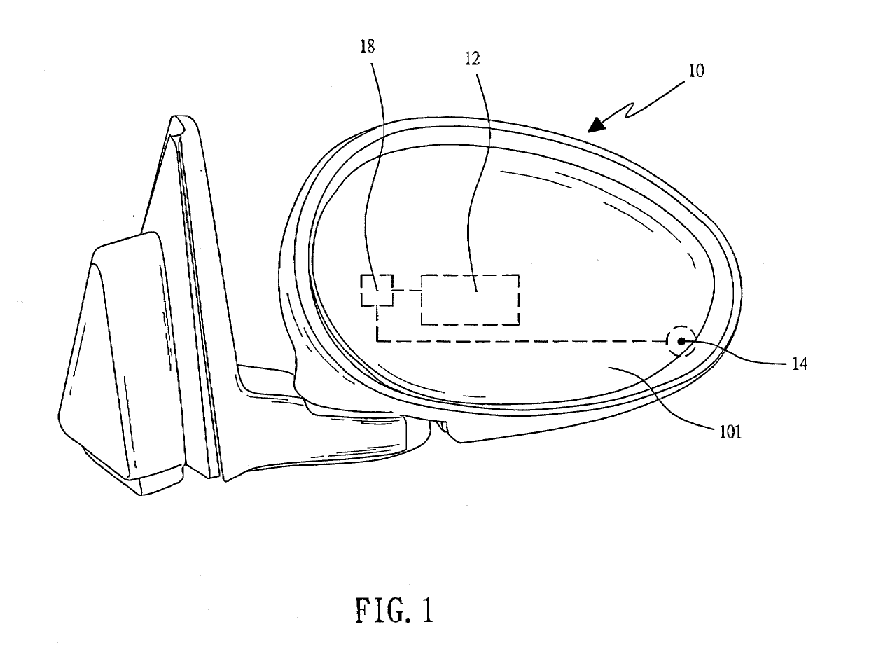

FIG. 2 is an embodiment for the vehicle detection and alert system with blind spot elimination function for the invention.

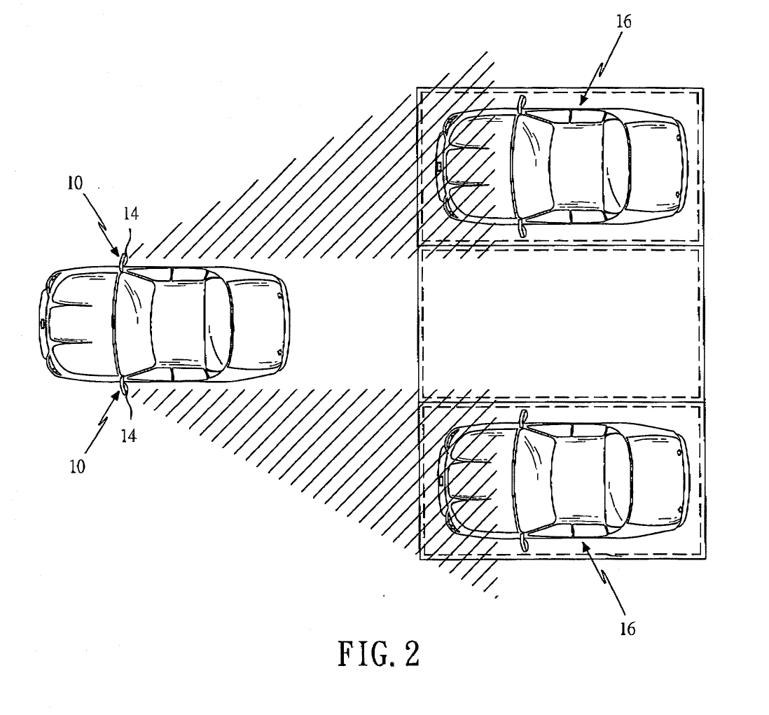

FIG. 3 is a block diagram to represent the vehicle detection and alert system with blind spot elimination function for the invention.

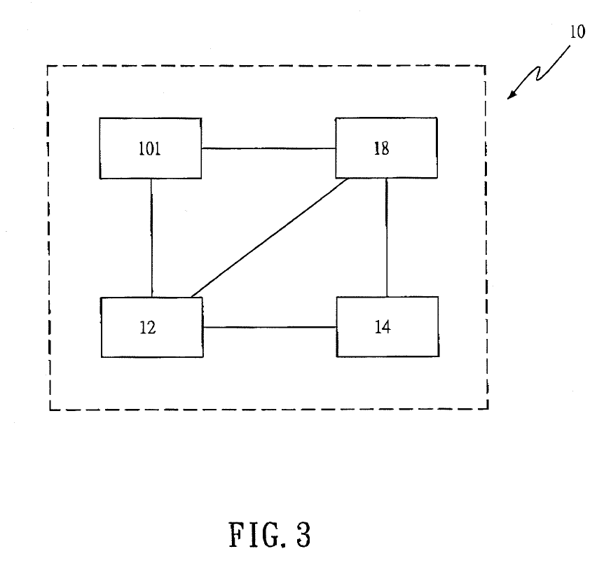

### Description of Main Components

| | | | |
|---|---|---|---|
| 10 | rear view mirror main body | 16 | vehicle |
| 101 | lens | 18 | control chip module |
| 12 | driving motor | 20 | digital image display unit |
| 14 | sensor | | |

What is claimed is:

1. A vehicle detection and alert system with blind spot elimination function at least consists of:
a rear view mirror main body that has a lens;
a driving motor that is installed inside the rear view mirror main body and connects to the lens to control lens angle;
a sensor that is installed inside the rear view mirror main body to detect the approaching objects or vehicles; and
a control chip module that is installed inside the rear view mirror main body and connects to the sensor and the driving motor to receive the detection signals from the sensor when foreign objects or vehicles are entering the blind spots and control the driving motor to obtain the optimal lens angle that allows the driver to easily see the foreign objects or vehicles entering the blind spots.

2. As described in claim 1 for a vehicle detection and alert system with blind spot elimination function, the control chip module communicates with the vehicle with wire connection.

3. As described in claim 1 for a vehicle detection and alert system with blind spot elimination function, the control chip module communicates with the vehicle with wireless connection.

4. As described in claim 1 for a vehicle detection and alert system with blind spot elimination function, the control chip module connects to the signal light switch stick, so through activating the signal light switch stick the control chip module sends out signals to control the lens angle.

5. As described in claim 1 for a vehicle detection and alert system with blind spot elimination function, the control chip module connects to the vehicle gearshift stick, so through activating the vehicle gearshift stick the control chip module sends out signals to control the lens angle.

6. As described in claim 1 for a vehicle detection and alert system with blind spot elimination function, the control chip module can memorize multiple lens angles.

7. As described in claim 1 for a vehicle detection and alert system with blind spot elimination function, the control chip module can memorize multiple lens angles for different drivers.

8. As described in claim 1 for a vehicle detection and alert system with blind spot elimination function, it can further contain a multi-angle control button to set the rear view mirror to the maximum angle by just one time operation when the vehicle is entering or exiting the ramp.

9. As described in claim 8 for a vehicle detection and alert system with blind spot elimination function, the multi-angle control button can be installed in a car door, a dashboard, a steering wheel or a gearshift stick, and connect to the control chip module.

10. As described in claim 9 for a vehicle detection and alert system with blind spot elimination function, the multi-angle control button can be installed in a car door, a dashboard, a steering wheel or a gearshift stick.

11. As described in claim 1 for a vehicle detection and alert system with blind spot elimination function, it can further contain a digital image display unit that provides real-time view for drivers and the digital image display unit connects to the control chip module and is installed inside the vehicle.
